(19) United States
(12) Patent Application Publication
(10) Pub. No.: US 2017/0055256 A1
(43) Pub. Date: Feb. 23, 2017

(54) METHOD AND APPARATUS FOR DETERMINING A FLEXIBLE SUBFRAME TYPE IN A LTE-TDD SYSTEM

(71) Applicants: ZTE CORPORATION, Shenzhen (CN); ZTE (TX) INC., Austin, TX (US)

(72) Inventor: Wenfeng ZHANG, Plano, TX (US)

(73) Assignee: ZTE Corporation, Shenzhen (CN)

(21) Appl. No.: 15/118,819

(22) PCT Filed: Feb. 10, 2015
(86) PCT No.: PCT/US2015/015222

§ 371 Date: Aug. 12, 2016

Related U.S. Application Data
(60) Provisional application No. 61/939,660, filed on Feb. 13, 2014.

(51) Int. Cl. H04W 72/04

(52) U.S. Cl. CPC H04W 72/0446

(57) ABSTRACT

A method of determining an uplink subframe type by user equipment includes the following steps: receiving an uplink grant from a base station, wherein the uplink grant is associated with a first flexible subframe within a first radio frame; determining a first index of the first flexible subframe within the first radio frame; identifying a second flexible subframe within a second radio frame; determining a second index of the second flexible subframe within the second radio frame; and determining a type for the second flexible subframe based at least on the first index of the first flexible subframe and the second index of the second flexible subframe. In some embodiments, the first and second radio frames are the same one. In other embodiments, the first and second radio frames are two different ones that fall within the same downlink/uplink configuration period.

### TECHNICAL FIELD

The present application generally relates to wireless communication and, in particular, to method and apparatus for determining the subframe types of a flexible subframe that can be dynamically configured to be either a downlink or an uplink subframe in the Long-Term Evolution (LTE) Time-Division Duplex (TDD) system.

### BACKGROUND

Advantages of the LTE-TDD system include the flexibility of bandwidth allocation in the unpaired frequency band, and the flexibility of choosing the downlink-to-uplink resource allocation ratio (referred to “D/U ratio” in this application). The latter one is more attractive because of the emerging traffic service types and traffic volume turbulence, both of which result in the wide range of D/U ratio. Once the D/U ratio is determined, it is usually informed to all served user equipments (referred to “UE” in this application) by a serving cell via broadcast signaling. Any subsequent changes of the existing D/U ratio are also done by the serving cell through broadcast signaling of the new D/U ratio.

### SUMMARY

The above deficiencies and other problems associated with the conventional approach of downlink-to-uplink resource allocation are at least partially solved by the method disclosed in the present application. In some embodiments, the present application is implemented in a computer system (e.g., a mobile phone, a tablet computer, etc.) that has one or more processors, memory and one or more modules, programs or sets of instructions stored in the memory for performing multiple functions. Instructions for performing these functions may be included in a computer program product configured for execution by one or more processors and stored in a non-transitory computer readable medium.

In accordance with some implementations, a method of determining an uplink subframe type by user equipment includes the following steps: receiving an uplink grant from a base station, wherein the uplink grant is associated with a first flexible subframe within a first radio frame; determining a first index of the first flexible subframe within the first radio frame; identifying a second flexible subframe within a second radio frame; determining a second index of the second flexible subframe within the second radio frame; and determining a type for the second flexible subframe based at least on the first index of the first flexible subframe and the second index of the second flexible subframe. In some embodiments, the first and second radio frames are the same one. In other embodiments, the first and second radio frames are two different ones that fall within the same downlink/uplink configuration period.

In accordance with some implementations, a user equipment includes one or more processors; a communication interfacing unit; a control unit for controlling the communication interfacing unit; a computer-readable storage medium; and one or more program instructions stored in the memory and to be executed by the processors and the control unit and the communication interfacing unit, collectively, the one or more program instructions further including: receiving an uplink grant from a base station, wherein the uplink grant is associated with a first flexible subframe within a first radio frame; determining a first index of the first flexible subframe within the first radio frame; identifying a second flexible subframe within a second radio frame; determining a second index of the second flexible subframe within the second radio frame; and determining a type for the second flexible subframe based at least on the first index of the first flexible subframe and the second index of the second flexible subframe.

In accordance with some implementations, a non-transitory computer readable storage medium storing one or more program instructions to be executed by a user equipment, the one or more program instructions further including: receiving an uplink grant from a base station, wherein the uplink grant is associated with a first flexible subframe within a first radio frame; determining a first index of the first flexible subframe within the first radio frame; identifying a second flexible subframe within a second radio frame; determining a second index of the second flexible subframe within the second radio frame; and determining a type for the second flexible subframe based at least on the first index of the first flexible subframe and the second index of the second flexible subframe.

### BRIEF DESCRIPTION OF DRAWINGS

The accompanying drawings, which are included to provide a further understanding of the invention and are incorporated herein and constitute a part of the specification, illustrate embodiments of the invention and together with the description serve to explain the principles of the invention. Like reference numerals refer to corresponding parts throughout the several views of the drawings.

FIG. 1 is a block diagram of a wireless communication system in accordance with some embodiments of the present application.

FIG. 2 is a block diagram illustrating the frame structure of a LTE-TDD system.

FIG. 3 is a block diagram illustrating the dynamic D/U configuration period and the UE determination of uplink subframes in accordance with some embodiments of the present application.

FIG. 4 is a block diagram illustrating the UE determination of uplink subframe type for subframe 3 in accordance with some embodiments of the present application.

FIG. 5 is a block diagram illustrating the UE determination of special subframe type for subframe 6 in accordance with some embodiments of the present application.

FIG. 6 is a flow chart of a method of determining an uplink subframe type in accordance with some embodiments of the present application.

### DETAILED DESCRIPTION

Reference will now be made in detail to embodiments, examples of which are illustrated in the accompanying drawings. In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented on many types of radio communication systems.

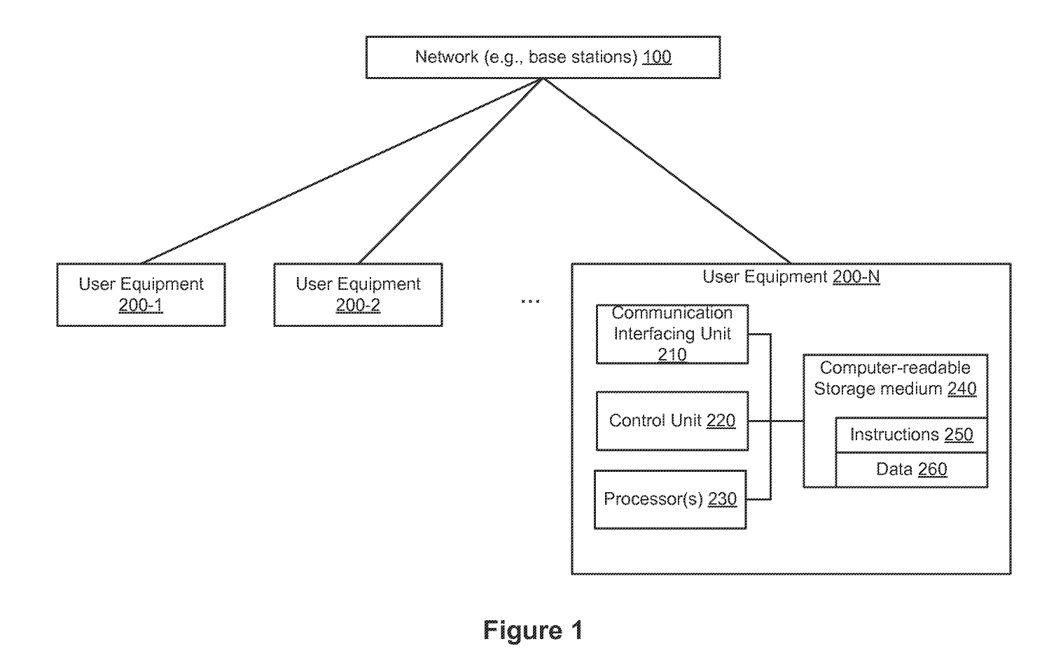

FIG. 1 is a block diagram of a wireless communication system in accordance with some embodiments of the present application. For example, the wireless communication system is an LTE-TDD system or other mobile communication systems that is composed of at least a network 100 and a plurality of user equipments (UEs) 200-1, 200-2, . . . , 200-N for illustrating the basic structure of the wireless communication system 10. Practically, the network 100 may be an evolved universal terrestrial radio access network (E-UTRAN) comprising a plurality of evolved base stations. The UEs 200 may be devices such as mobile phones, tablet computers, etc. According to their transmission directions, the network 100 and the UE 200 can be seen as a transmitter or receiver or vice versa. For example, for uplink, the UE 200 is the transmitter and the network 100 is the receiver, and for downlink, the network 100 is the transmitter and the UE 200 is the receiver.

As shown in FIG. 1, the UE 200-N further includes a communication interfacing unit 210, a control unit 220, one or more processors 230, and a computer readable storage medium 240. In some embodiments, the computer readable storage medium 240 is a data storage device that stores instructions 250 and associated data 260, which are read and processed by the processor 230. Examples of the computer readable storage medium 240 include a subscriber identity module (SIM), read-only memory (ROM), random-access memory (RAM), CD-ROMs, magnetic tapes, floppy disks, optical data storage devices, and carrier waves (such as data transmission through the Internet). The control unit 220 controls the communication interfacing unit 210 and related operations and states of the UE 200-N according to the processing results of the processor 230. In some embodiment, the communication interfacing unit 210 includes a radio transceiver for wirelessly communicating with the network 100.

In the LTE-TDD system, the minimum transmission time interval (TTI) is called “subframe”, whose time duration is one-tenth of one radio frame. Each radio frame of 10 ms contains 10 subframes. For the LTE-TDD system, a subframe can be a downlink subframe (marked as “D”), an uplink subframe (marked as “U”) or a special subframe (marked as “S”). Each special subframe includes three fields: a Downlink Pilot Timeslot (DwPTS), a Guard Period (GP), and an Uplink Pilot Timeslot (UpPTS). Note that DwPTS is used in the downlink direction, UpPTS is used in the uplink direction, and the GP is located between DwPTS and the UpPTS and it has no transmission.

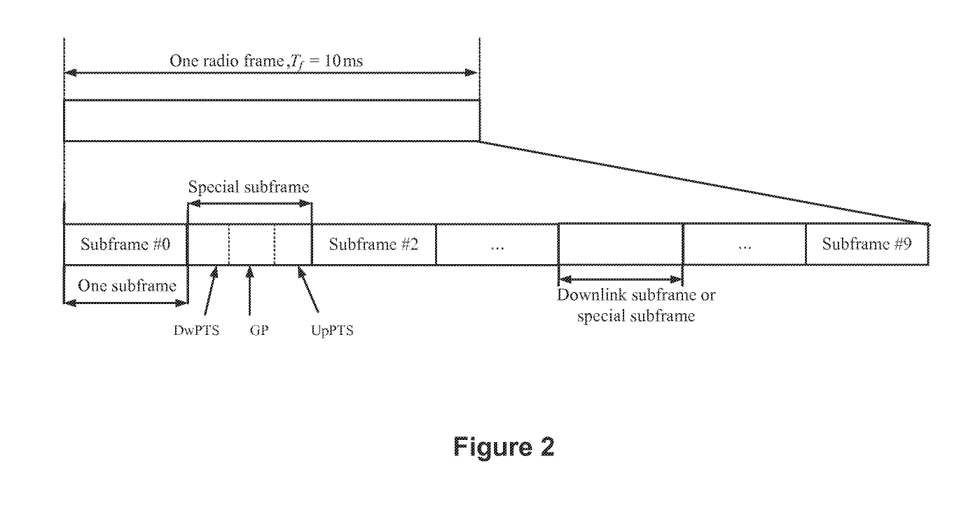

FIG. 2 is a block diagram illustrating the above-mentioned LTE-TDD frame structure. Note that a combination of choices on {D, U, S} in every one of ten subframes per radio frame constructs one TDD downlink-uplink configuration (also referred as “D/U configuration” in this application). For example, Table 1 below illustrates seven standard downlink-uplink configurations used by the current release of LTE-TDD system. These standard D/U configurations use either 5 ms or 10 ms switch-point periodicities. For the D/U configurations with 5 ms switch-point periodicity (e.g., the configurations indexed 0-2 and 6 in Table 1), a special subframe exists in both half frames. For the D/U configurations with 10 ms switch-point periodicity (e.g., the configurations indexed 3-5 in Table 1), the special subframe only exists in the first half frame. It can be seen from the table below that the subframes 0 and 5 as well as DwPTS are always reserved for the downlink transmission. It can also be seen that UpPTS and the subframe immediately following the special subframe are always reserved for the uplink transmission.

TABLE 1
Downlink-uplink configurations in LTE-TDD System

| D/U Con- | Switch-point | Subframe number | | | | | | | | | |
|---|---|---|---|---|---|---|---|---|---|---|---|
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In the current release of LTE-TDD system, the D/U configuration (indexed 0-6 as shown in Table 1 above) is contained in the system information block (SIB) that is periodically broadcasted by the serving cell. However, there are various restrictions related to the modification of the SIB content. For example, it may take as long as about 640 ms to reconfigure the D/U configuration to a new value and the total number of modifications to the SIB content is also limited within a certain time period (e.g., no more than 32 times in 3 hours). However, due to the rapid change of traffic volume, these restrictions make it challenging to fully exploit the flexibilities offered by the LTE-TDD system by adapting the D/U configuration to the traffic variation via broadcast signaling in SIB.

As a result, various proposals have been made to dynamically change the D/U configuration as fast as per radio frame without modification of the D/U configuration in SIB. For example, as shown in Table 1 above, the subframe 3 is an uplink subframe for the D/U configurations indexed {0, 1, 3, 4, 6} and a downlink subframe for the D/U configurations indexed {2, 5}. Similarly, the subframe 6 is a special subframe for the D/U configurations indexed {0, 1, 2, 6} and a downlink subframe for the D/U configurations indexed {3, 4, 5}. In other words, some of the subframes can be configured to be dynamically converted between downlink subframe and uplink subframe if they belong to subframes {3, 4, 7, 8, 9}, or between downlink subframe and special subframe if the subframe belongs to subframe {6}. Collectively, these subframes {3, 4, 6, 7, 8, 9} are called “flexible subframes”. The other subframes {0, 1, 2, 5} in the radio frame are called “fixed subframe” because their subframe types remain unchanged for all the seven D/U configurations shown in Table 1. Once the D/U configuration is dynamically changed, it may remain unchanged for a period chosen from {10 ms, 20 ms, 40 ms, 80 ms}, and each period boundary aligns to the integer multiple of {10 ms, 20 ms, 40 ms, 80 ms}, respectively.

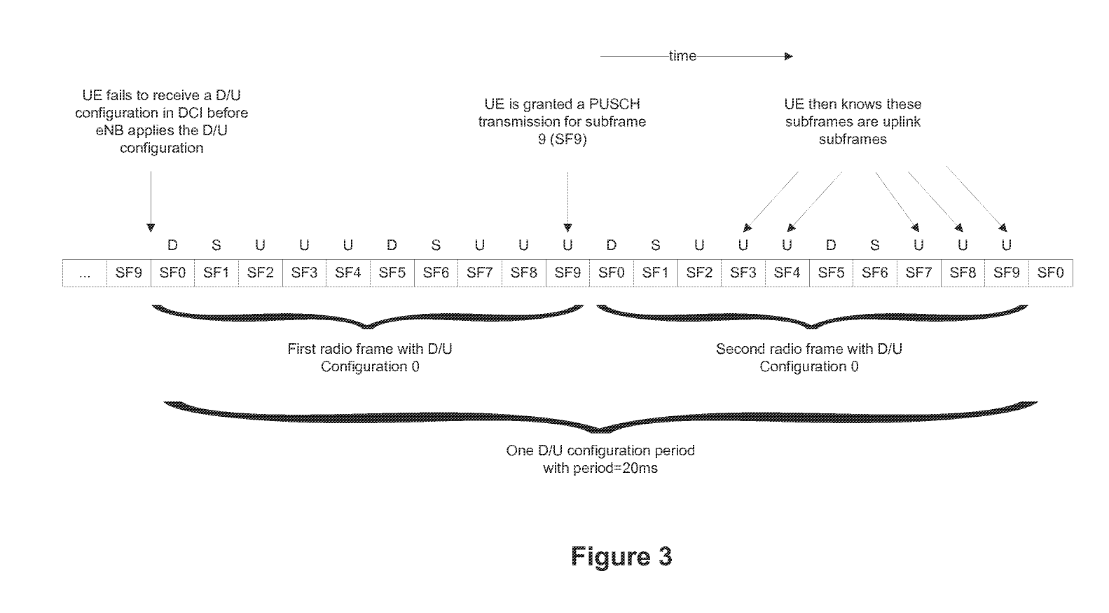

FIG. 3 shows one example of a dynamic configuration period of 20 ms, which contains two consecutive radio frames that are both dynamically changed to D/U configuration indexed 0, which has a switch-point period of 5 ms. In some embodiments, the dynamic change of D/U configuration is controlled by the base station (also referred as “eNB” or “cell” in this application), which informs a mobile station (also referred as “User Equipment” or “UE” in this application) of the change via the downlink control information (DCI) that is transmitted on the physical downlink control channel (PDCCH) before the base station applies the change. PDCCH/DCI is CRC protected. As shown in FIG. 3, when the noisy wireless channel corrupts the reception of PDCCH/DCI at the UE, CRC fails and the UE ignores the received DCI. Accordingly, the D/U configuration information contained in the ignored DCI is also lost. Without knowledge of the upcoming D/U configuration, the UE does not know what subframe type a flexible subframe is actually changed to. When this situation occurs, the UE has to rely on a fallback operation, which usually involves more conservative hypothesis of the D/U configuration and is therefore more resource-consuming.

On the other hand, the D/U configurations shown in Table 1 have certain features that can be used to minimize the negative performance impact of the fallback operation. More specifically, if a UE running in a D/U reconfiguration period does not successfully detects a valid D/U configuration via DCI (e.g., due to the noisy wireless channel), it is possible for the UE to judge the type of a flexible subframe based on information other than the dynamic reconfiguration DCI, which is communicated between the base station and the UE before the corresponding flexible subframe occurs. For example, as shown in Table 1, the three consecutive subframes {2, 3, 4} and three consecutive subframes {7, 8, 9} in all D/U configurations indexed 0-6 share a unique pattern property, that is, any uplink subframe only occurs prior to all downlink subframes. In other words, there is no downlink subframe immediately before any uplink subframe in any D/U configuration.

For example, as shown in FIG. 3, if the UE receives an UL grant for the physical uplink shared channel (PUSCH) to be transmitted in subframe 9, not only does the UE know that the subframe 9 is the uplink subframe, it also knows that the subframes {7, 8} are also uplink subframes according to Table 1. One aspect of the present application is to provide a method for the UE to determine the type of a flexible subframe based on the PUSCH transmission scheduling grants that are received by the UE prior to the flexible subframe, of which the subframe type needs to be determined.

Assuming that a subframe is a flexible subframe and its subframe index in the radio frame is k₀ (0≦k₀≦9), it is determined by the UE to be an uplink subframe if the UE receives at least one uplink grant for the PUSCH that is to be transmitted by the UE in a subframe whose subframe index belongs to the index set SI and whose associated radio frame falls within the same D/U configuration period as the corresponding flexible subframe to be determined. More specifically,

For k₀=3, Ω={3, 4, 8, 9}.

For k₀=4, Ω={4, 9}.

For k₀=7, Ω={7, 8, 9}.

For k₀=8, Ω={8, 9}.

For k₀=9, Ω={9}.

As shown in FIG. 3, assuming that UE receives an uplink grant for the PUSCH that is to be transmitted by the UE in the subframe indexed 9, the UE can then determine that the subframes indexed {3, 4, 7, 8, 9} of the radio frame that falls within the same D/U configuration period of 20 ms are uplink subframes.

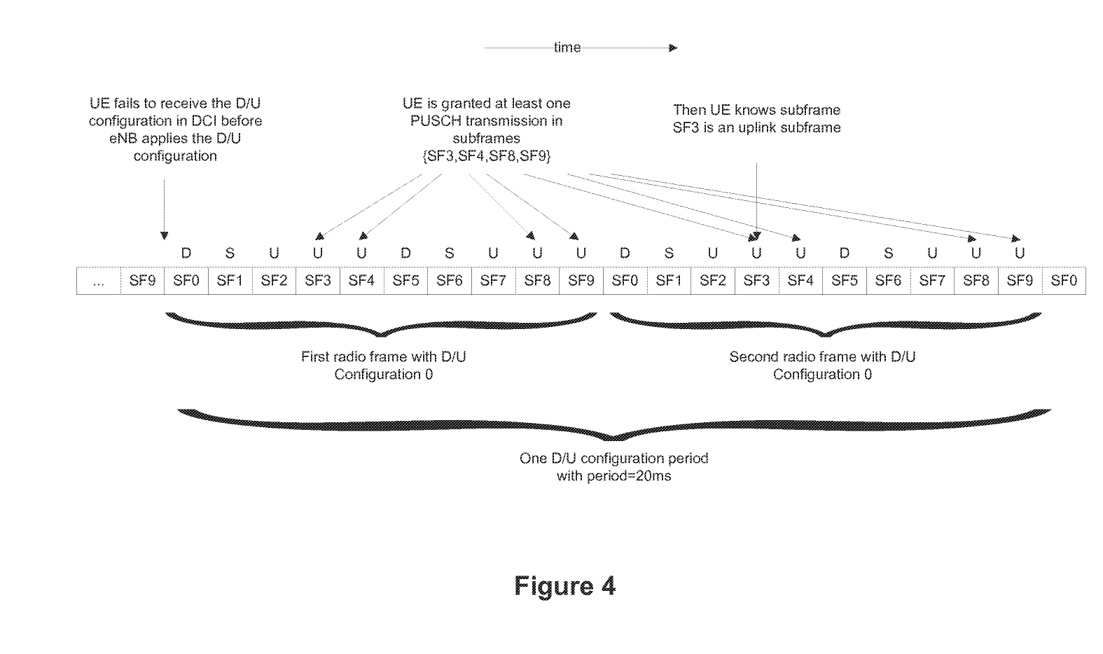

FIG. 4 shows another example of how the UE determines the flexible subframe type for the subframe SF3. As shown above in Table 1, the subframe SF3 is a flexible subframe whose type is “U” for the D/U configurations indexed {0, 1, 3, 4, 6} or “D” for the D/U configurations indexed {2, 5}. If the UE is granted at least one PUSCH transmission in one of the subframes {SF3, SF4, SF8, SF9}, the UE can then determine that the subframe SF3 in the second radio frame within the same D/U configuration period is an uplink subframe.

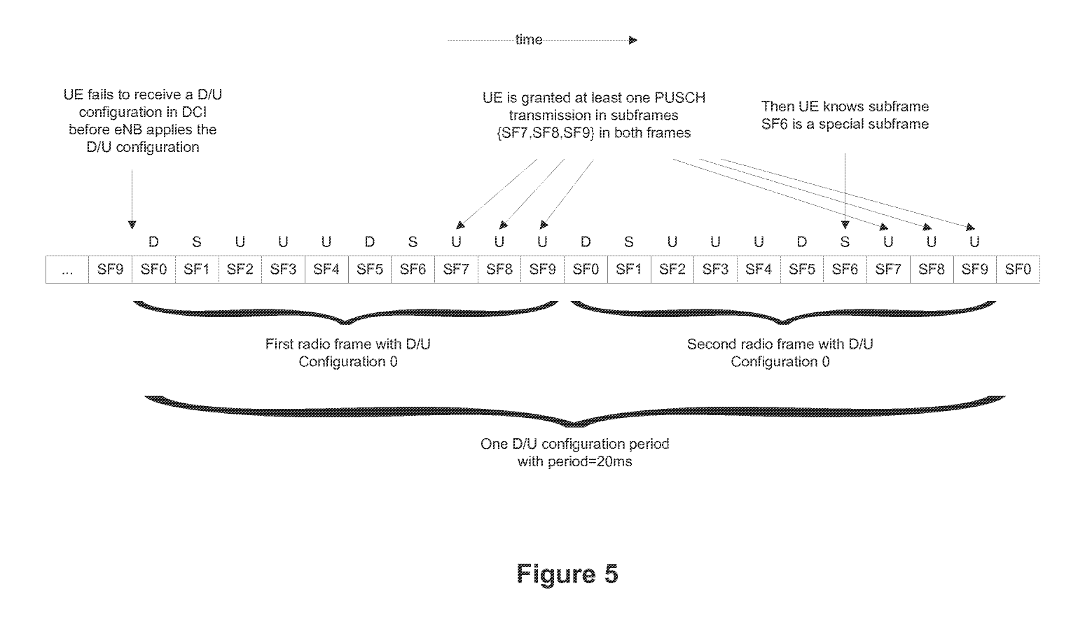

FIG. 5 depicts yet another example of how the UE determines the flexible subframe type for the subframe SF6. As shown above in Table 1, the subframe SF6 is also a flexible subframe whose type is “S” for the D/U configurations indexed {0, 1, 2, 6} or “D” for the D/U configurations indexed {3, 4, 5}. Assuming that the UE receives at least one uplink grant for PUSCH that is to be transmitted by the UE in a subframe whose subframe index belongs to the index set Ω={7, 8, 9} and whose radio frame instance falls within the same configuration period as the corresponding flexible subframe to be judged, the UE can determine that the subframe SF6 of the second radio frame is a special subframe.

Depending on the robustness requirement for this method, the PUSCH to be detected can be either non-semi-persistent (non-SPS) scheduled or semi-persistent (SPS) scheduled. It can also be either the initial PUSCH transmission in a HARQ process or any transmission instance in a HARQ process. With this capability of determining the flexible subframe type to be either uplink subframe or special subframe containing UpPTS, the UE can ensure that its uplink transmission using flexible subframes does not encounter a subframe dynamically changed by the base station to a regular downlink subframe. The mentioned uplink transmission includes but not limited to PUSCH and sounding reference signaling (SRS).

In some embodiments, the above-described method and its variations may be implemented as computer software instructions or firmware instructions. Such instructions may be stored in an article with one or more machine-readable storage devices connected to one or more computers or digital processors such as digital signal processors and microprocessors as described above in connection with FIG. 1. In a communication system, the LTE-TDD subframe type determination depending on other than the dynamic reconfiguration information in DCI and its process may be implemented in form of software instructions or firmware instructions for execution by a processor. In operation, the instructions are executed by one or more processors to cause the transmitter or its transmission controller and receiver or receiver controller to perform the described functions and operations.

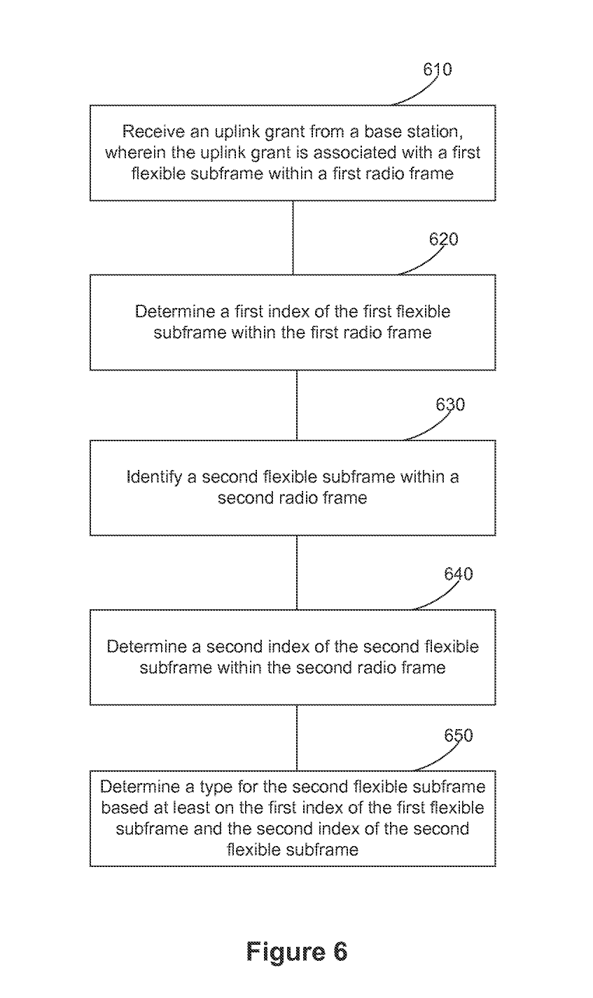

In sum, FIG. 6 depicts a flow chart of a method of determining an uplink subframe type by user equipment in accordance with some embodiments of the present application. The method includes the following steps: receiving (610) an uplink grant from a base station, wherein the uplink grant is associated with a first flexible subframe within a first radio frame; determining (620) a first index of the first flexible subframe within the first radio frame; identifying (630) a second flexible subframe within a second radio frame; determining (640) a second index of the second flexible subframe within the second radio frame; and determining (650) a type for the second flexible subframe based at least on the first index of the first flexible subframe and the second index of the second flexible subframe.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for determining flexible subframe types within a radio frame at a user equipment, comprising:
receiving an uplink grant from a base station, wherein the uplink grant is associated with a first flexible subframe within a first radio frame;
determining a first index of the first flexible subframe within the first radio frame;
identifying a second flexible subframe within a second radio frame;
determining a second index of the second flexible subframe within the second radio frame; and
determining a type for the second flexible subframe based at least on the first index of the first flexible subframe and the second index of the second flexible subframe.

2. The method of claim 1, wherein the second flexible subframe is an uplink subframe when the second index of the second flexible subframe is 3 and the first index of the first flexible subframe is one of {4, 8, 9}.

3. The method of claim 1, wherein the second flexible subframe is an uplink subframe when the second index of the second flexible subframe is 4 and the first index of the first flexible subframe is 9.

4. The method of claim 1, wherein the second flexible subframe is an uplink subframe when the second index of the second flexible subframe is 7 and the first index of the first flexible subframe is one of {8, 9}.

5. The method of claim 1, wherein the second flexible subframe is an uplink subframe when the second index of the second flexible subframe is 8 and the first index of the first flexible subframe is 9.

6. The method of claim 1, wherein the uplink grant for the physical uplink shared channel (PUSCH) that is to be transmitted by the UE.

7. The method of claim 1, wherein the first radio frame and the second radio frame are the same radio frame.

8. The method of claim 1, wherein the first radio frame and the second radio frame are two different radio frames that fall within the same downlink/uplink configuration period.

9. The method of claim 1, wherein the second flexible subframe is a special subframe when the second index of the second flexible subframe is 6 and the first index of the first flexible subframe is one of {7, 8, 9}.

10. A user equipment, comprising:
one or more processors;
a communication interfacing unit;
a control unit for controlling the communication interfacing unit;
a computer-readable storage medium; and
one or more program instructions stored in the memory and to be executed by the processors and the control unit and the communication interfacing unit, collectively, the one or more program instructions further including:
receiving an uplink grant from a base station, wherein the uplink grant is associated with a first flexible subframe within a first radio frame;
determining a first index of the first flexible subframe within the first radio frame;
identifying a second flexible subframe within a second radio frame;
determining a second index of the second flexible subframe within the second radio frame; and
determining a type for the second flexible subframe based at least on the first index of the first flexible subframe and the second index of the second flexible subframe.

11. The user equipment of claim 10, wherein the second flexible subframe is an uplink subframe when the second index of the second flexible subframe is 3 and the first index of the first flexible subframe is one of {4, 8, 9}.

12. The user equipment of claim 10, wherein the second flexible subframe is an uplink subframe when the second index of the second flexible subframe is 4 and the first index of the first flexible subframe is 9.

13. The user equipment of claim 10, wherein the second flexible subframe is an uplink subframe when the second index of the second flexible subframe is 7 and the first index of the first flexible subframe is one of {8, 9}.

14. The user equipment of claim 10, wherein the second flexible subframe is an uplink subframe when the second index of the second flexible subframe is 8 and the first index of the first flexible subframe is 9.

15. The user equipment of claim 10, wherein the uplink grant for the physical uplink shared channel (PUSCH) that is to be transmitted by the UE.

16. The user equipment of claim 10, wherein the first radio frame and the second radio frame are the same radio frame.

17. The user equipment of claim 10, wherein the first radio frame and the second radio frame are two different radio frames that fall within the same downlink/uplink configuration period.

18. The user equipment of claim 10, wherein the second flexible subframe is a special subframe when the second index of the second flexible subframe is 6 and the first index of the first flexible subframe is one of {7, 8, 9}.

19. A non-transitory computer readable storage medium storing one or more program instructions to be executed by a user equipment, the one or more program instructions further including:
receiving an uplink grant from a base station, wherein the uplink grant is associated with a first flexible subframe within a first radio frame;
determining a first index of the first flexible subframe within the first radio frame;
identifying a second flexible subframe within a second radio frame;
determining a second index of the second flexible subframe within the second radio frame; and
determining a type for the second flexible subframe based at least on the first index of the first flexible subframe and the second index of the second flexible subframe.
